(19) United States
(12) Patent Application Publication
(10) Pub. No.: US 2017/0025925 A1
(43) Pub. Date: Jan. 26, 2017

(54) POWER GENERATING SYSTEM HAVING MULTI-STAGE TRANSMISSION STRUCTURE

(71) Applicants: PO-HENG LIN, TAOYUAN CITY (TW); GRAND POWER SYSTEM TECHNOLOGY CORPORATION, NEW TAIPEI CITY (TW)

(72) Inventor: SHENG-YEH WU, TAIPEI (TW)

(21) Appl. No.: 14/803,208

(22) Filed: Jul. 20, 2015

(51) Int. Cl. H02K 7/18; F03G 5/06; F16H 7/12

(52) U.S. Cl. CPC H02K 7/1861; F16H 7/1254; F03G 5/06; F16H 2007/0842

(57) ABSTRACT

Disclosed is a power generating system, comprising a multi-stage transmission structure, a power generating device, a manual operation module. The multi-stage transmission structure includes a driving module and a transmission module. The driving module includes a first driving wheel and a first transmission wheel with a smaller diameter. The first driving wheel and the first transmission wheel have a plurality of guiding trenches at respective outer edges, and are linked with each other through a first transmission belt. The transmission module includes a second transmission wheel and a second driving wheel. The second transmission wheel has a greater diameter than the first transmission wheel and the second driving wheel and is coaxially disposed with the first transmission wheel. The manual operation module can enable a user to rotate the first driving wheel and thus carry the second driving wheel so that the power generating device generates power.

### BACKGROUND OF THE INVENTION

1. Field of the Invention

The present invention relates to a power generating system having a multi-stage transmission structure, and in particular, to a power generating system used as a sports apparatus and capable of generating power when a user is exercising.

2. Description of Related Art

With increasingly busy lives, persons living in cities are increasingly finding it difficult to take a long time to exercise. Therefore, many persons place various kinds of sports apparatuses at home. In this way, the exercise and fitness effects can be achieved by using little time even if persons do not go out. Generally, various exercise bicycles are provided with small display devices, so as to provide users with information such as used time and consumed heat. In order to supply power for the display device, besides providing a replaceable battery directly, manufacturers have developed power generating exercise bicycles capable of converting kinetic energy produced from user's treading into electric energy.

Nowadays, in most of the power generating exercise bicycles, a planetary gear structure is disposed in an inner ring surface of a flywheel, thereby achieving the purpose of generating power with engagement of gears. However, such a conventional structure has many problems. For example, a complex gear structure is required to drive a power generating module to generate power and the power generating module has poor power generating efficiency. Therefore, based on intensive research and in combination with scientific principle, the inventor proposes this invention that has reasonable design and effectively improves the aforementioned problems.

### SUMMARY OF THE INVENTION

The main objective of the present invention is to provide a power generating system having a multi-stage transmission structure, for solving the problems in the prior art that a power generating system used in a sports apparatus has a complex transmission structure and has poor power generating efficiency.

For achieving the aforementioned objective, the present invention provides a power generating system having a multi-stage transmission structure, comprising a multi-stage transmission structure, a power generating device, a manual operation module, and a tension adjusting device. The multi-stage transmission structure includes a driving module and a transmission module. The driving module includes a first driving wheel, a first transmission wheel, and a first transmission belt. The first driving wheel has a diameter greater than that of the first transmission wheel, and the first transmission belt is disposed around the first driving wheel and the first transmission wheel, so that the first driving wheel is capable of carrying the first transmission wheel. The first driving wheel and the first transmission wheel have a plurality of guiding trenches at respective outer edges, and the first transmission belt has a plurality of guiding structures. When the first transmission belt is disposed around the first driving wheel and the first transmission wheel, the guiding structures are correspondingly engaged in the guiding trenches. The transmission module includes a second transmission wheel, a second driving wheel, and a second transmission belt. The second transmission wheel is coaxially disposed with the first transmission wheel and rotates synchronously with the first transmission wheel. The second transmission wheel has a diameter greater than that of the first transmission wheel and the second driving wheel. When the second transmission belt is disposed around the second transmission wheel and the second driving wheel, the second transmission wheel is capable of carrying the second driving wheel to rotate. The power generating device includes a rotation shaft, and the second driving wheel is disposed around the rotation shaft. The manual operation module is connected to the first driving wheel, to enable a user to drive the first driving wheel to rotate, and thus carry the second driving wheel and the rotation shaft to rotate through the first transmission belt, the first transmission wheel, and the second transmission belt, so that the power generating device generates power. The tension adjusting device is disposed adjacent to the first transmission belt to adjust tension of the first transmission belt.

The beneficial effects of the present invention are in that, through the diameter relationship between the first driving wheel and the first transmission wheel, the diameter relationship between the first transmission wheel and the second transmission wheel, and the diameter relationship between the second transmission wheel and the second driving wheel, the power generating efficiency can be effectively improved, and through the provision of the guiding trenches and the guiding structures, the problem that the transmission belts slide during user operation can be effectively avoided.

In order to further understand the features and technical content of the present invention, reference is made to the following detailed description and accompanying drawings of the present invention. However, the accompanying drawings are only intended for reference and illustration, but do not limit the present invention.

### BRIEF DESCRIPTION OF THE DRAWINGS

FIG. 1 and FIG. 2 are exploded schematic views of a power generating system having a multi-stage transmission structure according to a first embodiment of the present invention;

FIG. 3, FIG. 4, and FIG. 5 are assembled schematic views of the power generating system having a multi-stage transmission structure of the present invention;

FIG. 6 is a schematic diagram showing that a tension adjusting device of the power generating system having a multi-stage transmission structure of the present invention is in a first position;

FIG. 7 is a schematic diagram showing that the tension adjusting device of the power generating system having a multi-stage transmission structure of the present invention is in a second position;

FIG. 8 is an exploded schematic view of a power generating system having a multi-stage transmission structure according to a second embodiment of the present invention; and

FIG. 9 and FIG. 10 are assembled schematic views of the power generating system having a multi-stage transmission structure according to the second embodiment of the present invention.

### DETAILED DESCRIPTION OF THE PREFERRED EMBODIMENTS

Embodiments of a power generating system having a multi-stage transmission structure of the present invention are described below with specific examples. Other advantages and effects of the present invention can be easily understood by persons skilled in the art according to the content disclosed in this specification. The present invention may also be implemented as or applied in other different specific examples. Various modifications and variations can be made to details in this specification based on different views and applications without departing from the spirit of the present invention. It is noted that the drawings of the present invention are only intended for illustration and are not drawn to scale, that is, actual dimensions of relevant components are not reflected. The following embodiments are used to further describe the concept of the present invention in detail, but are not intended to limit the scope of the present invention in any way.

### First Embodiment

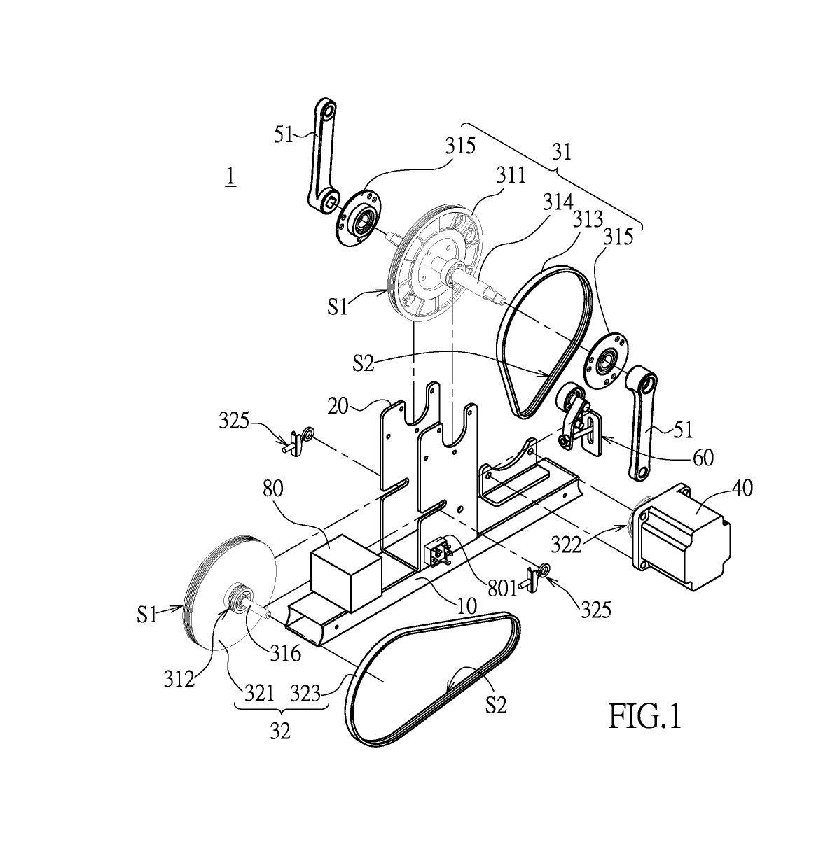

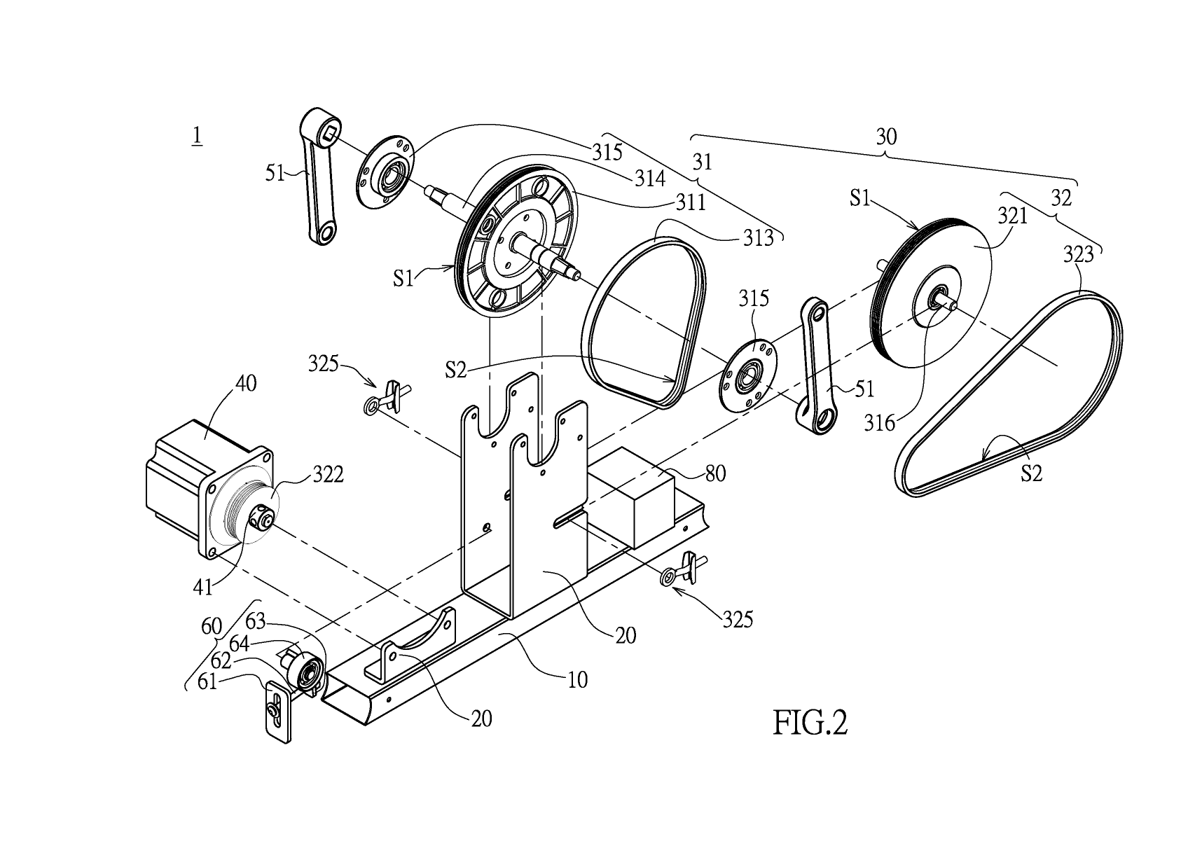

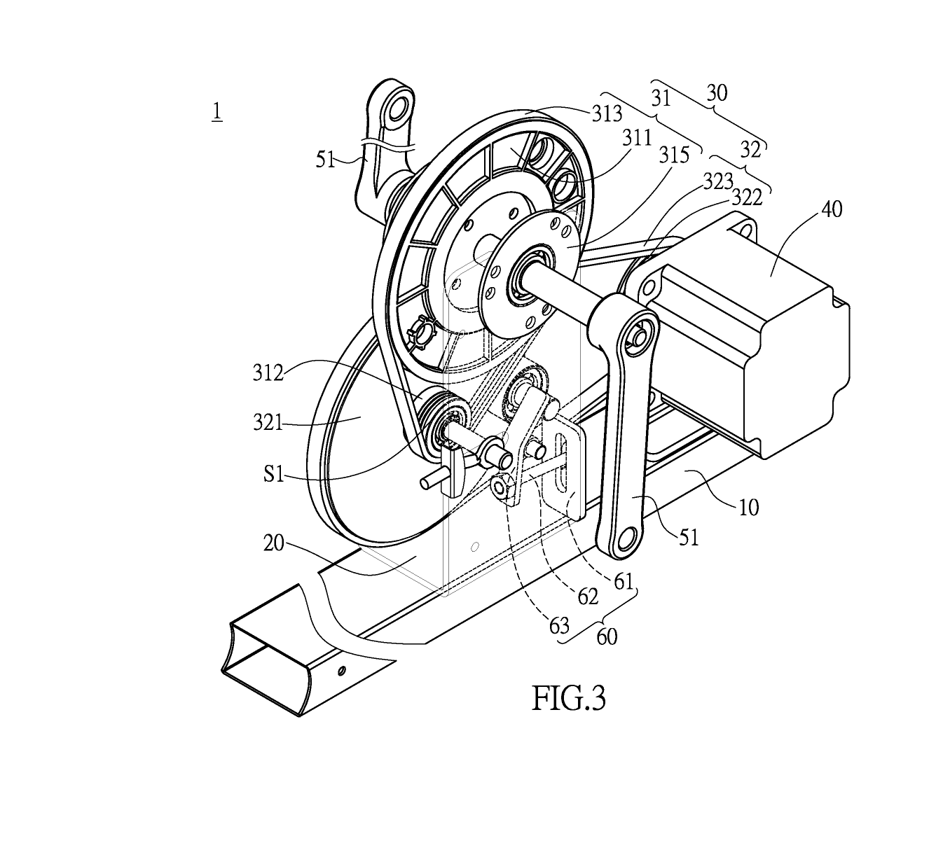

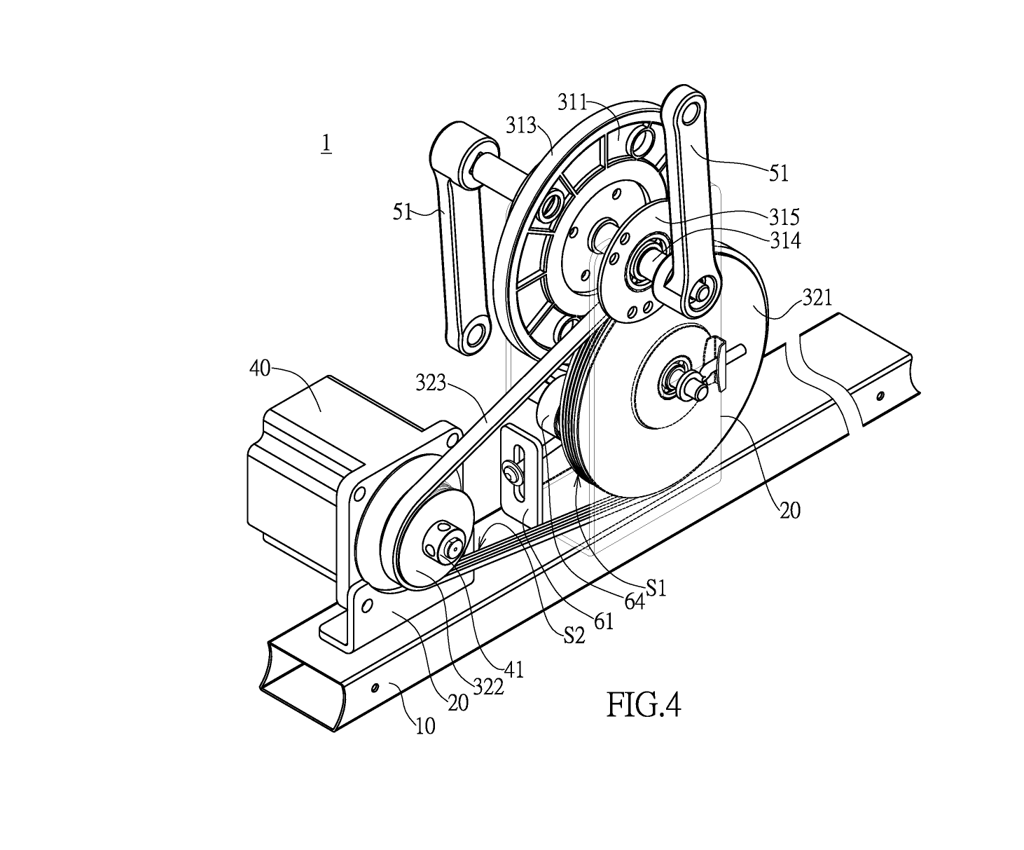

Referring to FIG. 1 to FIG. 5, exploded and assembled schematic views of a power generating system according to a first embodiment of the present invention are shown. As shown, a power generating system 1 comprises a base 10, a support 20, a multi-stage transmission structure 30, a power generating device 40, a manual operation module 50, and a tension adjusting device 60. The support 20, the power generating device 40, and the tension adjusting device 60 are disposed on the base 10, the multi-stage transmission structure 30 is fixedly disposed on the support 20, and the manual operation module 50 is connected to the multi-stage transmission structure 30. The form and appearance of the base 10 and the support 20 may be selected according to requirements and are not limited to the aspects shown in the figures.

Further, the multi-stage transmission structure 30 includes a driving module 31 and a transmission module 32. The driving module 31 includes a first driving wheel 311, a first transmission wheel 312, a first transmission belt 313, a driving shaft 314, a fixing component 315, and a transmission shaft 316. The first driving wheel 311 is fixedly disposed on the driving shaft 314, the fixing component 315 is disposed around the driving shaft 314 at both sides of the first driving wheel 311 and the fixing component 315 is fixedly disposed on the support 20. In other words, the first driving wheel 311 is rotatablely disposed on the support 20 through the driving shaft 314 and the fixing component 315. The first transmission wheel 312 is fixedly disposed on the transmission shaft 316 and the transmission shaft 316 is pivotally disposed on the support 20. The diameter of the first driving wheel 311 is greater than that of the first transmission wheel 312.

The first transmission belt 313 is disposed around outer edges of the first driving wheel 311 and the first transmission wheel 312. The first driving wheel 311 and the first transmission wheel 312 have a plurality of guiding trenches S1 at respective outer edges, and the first transmission belt 313 correspondingly has a plurality of guiding structures S2 at an inner side. For example, the first transmission belt 313 may be a timing belt or a toothed belt. When the first transmission belt 313 is disposed around the outer edges of the first driving wheel 311 and the first transmission wheel 312, the guiding structures S2 of the first transmission belt 313 are correspondingly engaged in the guiding trenches S1, so that when the first driving wheel 311 rotates, the first transmission belt 313 is not easy to slide on the first driving wheel 311 and the first transmission wheel 312. That is, through the provision of the guiding trenches S1 and the guiding structures S2, the first transmission wheel 312 can be more effectively carried by the first driving wheel 311 to rotate through the first transmission belt 313. For example, the guiding trenches S1 and the guiding structures S2 may be annularly disposed on the first transmission belt 313 and the first driving wheel 311 and the first transmission wheel 312, respectively, whereby the first transmission belt 313 is effectively prevented from sliding in a direction parallel to a central axis of the first driving wheel 311 or the first transmission wheel 312.

The transmission module 32 includes a second transmission wheel 321, a second driving wheel 322, and a second transmission belt 323. The second transmission wheel 321 is coaxially disposed with the first transmission wheel 312 and rotates synchronously with the first transmission wheel 312. In this embodiment, the second transmission wheel 321 is integrally formed with the first transmission wheel 312, the second transmission wheel 321 and the first transmission wheel 312 are pivotally disposed on the same transmission shaft 316, and the transmission shaft 316 is fixed on the support 20 through a plurality of fastening members 325. However, other configurations may be used in the actual application. The diameter of the second transmission wheel 321 is greater than that of the first transmission wheel 312 and that of the second driving wheel 322, that is, the diameters of the first transmission wheel 312 and the second driving wheel 322 are both less than the diameter of the second transmission wheel 321.

The second transmission belt 323 is disposed around outer edges of the second transmission wheel 321 and the second driving wheel 322, so that the second driving wheel 322 can be driven by the second transmission wheel 321. In a preferred embodiment, the second transmission wheel 321 and the second driving wheel 322 may have a plurality of guiding trenches S1 at respective outer edges, and the second transmission belt 323 may correspondingly have a plurality of guiding structures S2, whereby the second transmission belt 323 can be effectively prevented from sliding on the outer edge of the second transmission wheel 321 or the second driving wheel 322 when the second transmission wheel 321 rotates.

The power generating device 40 has a rotation shaft 41. The second driving wheel 322 is fixedly disposed on the rotation shaft 41, to carry the rotation shaft 41 to rotate, so that the power generating device 40 converts kinetic energy generated by the rotation of the rotation shaft 41 into electric energy and directly stores the electric energy in a power storage device 80. In a preferred embodiment, the power generating device 40 may be a brushless three-phase alternator, which can generate a three-phase alternating-current, and can convert, through a bridge rectifier 801 and a filter (not shown), the three-phase alternating-current into a direct current capable of being directly stored in the power storage device 80. Furthermore, the power storage device 80 may be further provided with a voltage stabilization circuit and a voltage transformation circuit if desired, so as to stably generate a certain desired voltage.

The manual operation module 50 includes two operation assemblies each including an operation member 51 and a harness 52. Two operation members 51 are disposed at two ends of the driving shaft 314 respectively, and the harness 52 is disposed on an end of each operation member 51 opposite to the end connected to the driving shaft 314. Specifically, each operation member 51 may be a crank and the harness 52 may be a member for a user to insert a foot or hand therein or may be a pedal.

The tension adjusting device 60 may include a support 61, an adjusting unit 62, a linkage unit 63, and a roller wheel 64. The support 61 is fixedly disposed on the base 10. The adjusting unit 62 and the linkage unit 63 are connected to each other, and an end of the adjusting unit 62 is movably disposed on the support 61. The roller wheel 64 and the linkage unit 63 are connected to each other, and the roller wheel 64 can be moved with the linkage unit 63 to be close to or far away from the first transmission belt 313 to abut against the first transmission belt 313, thereby adjusting and controlling the tension of the first transmission belt 313.

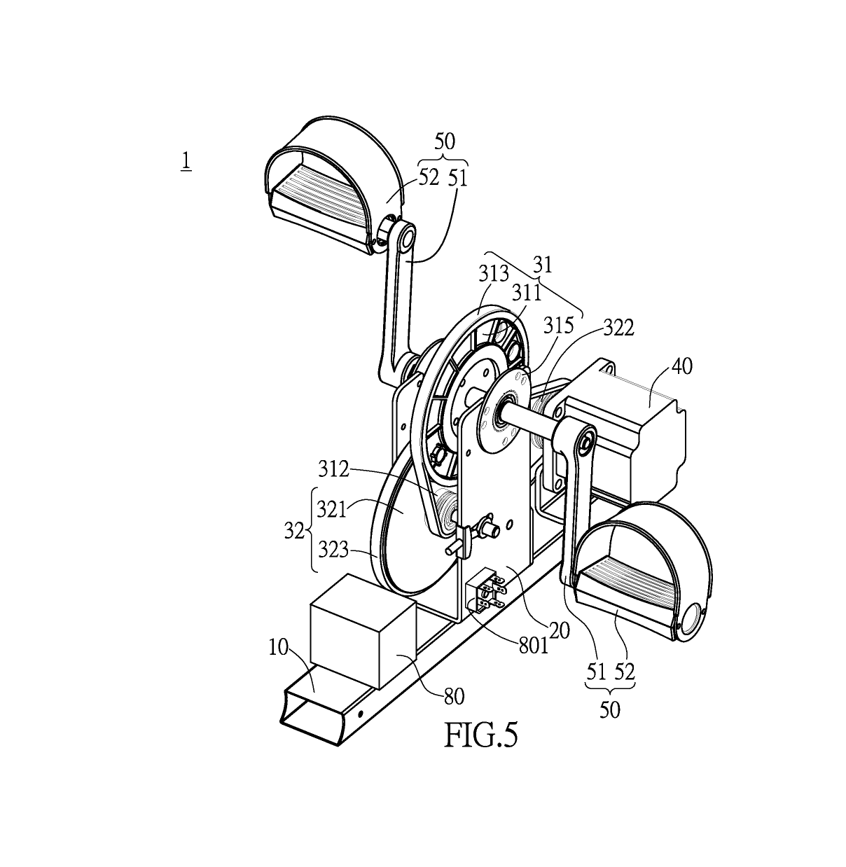

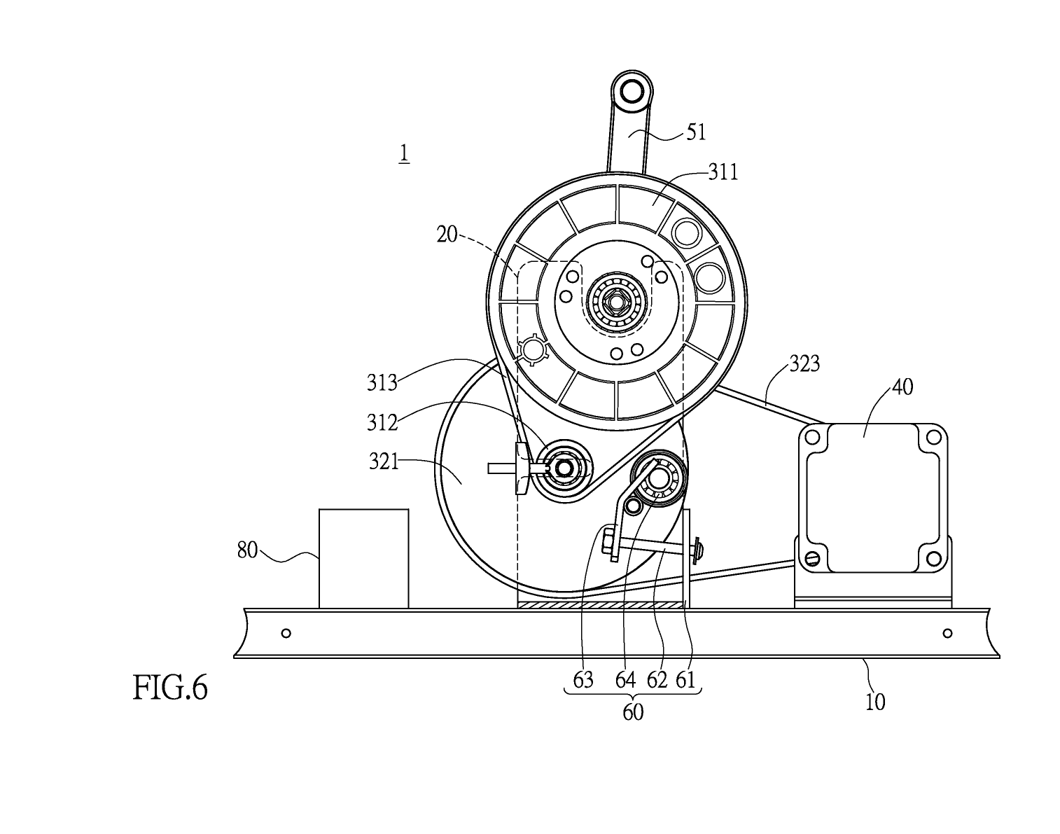

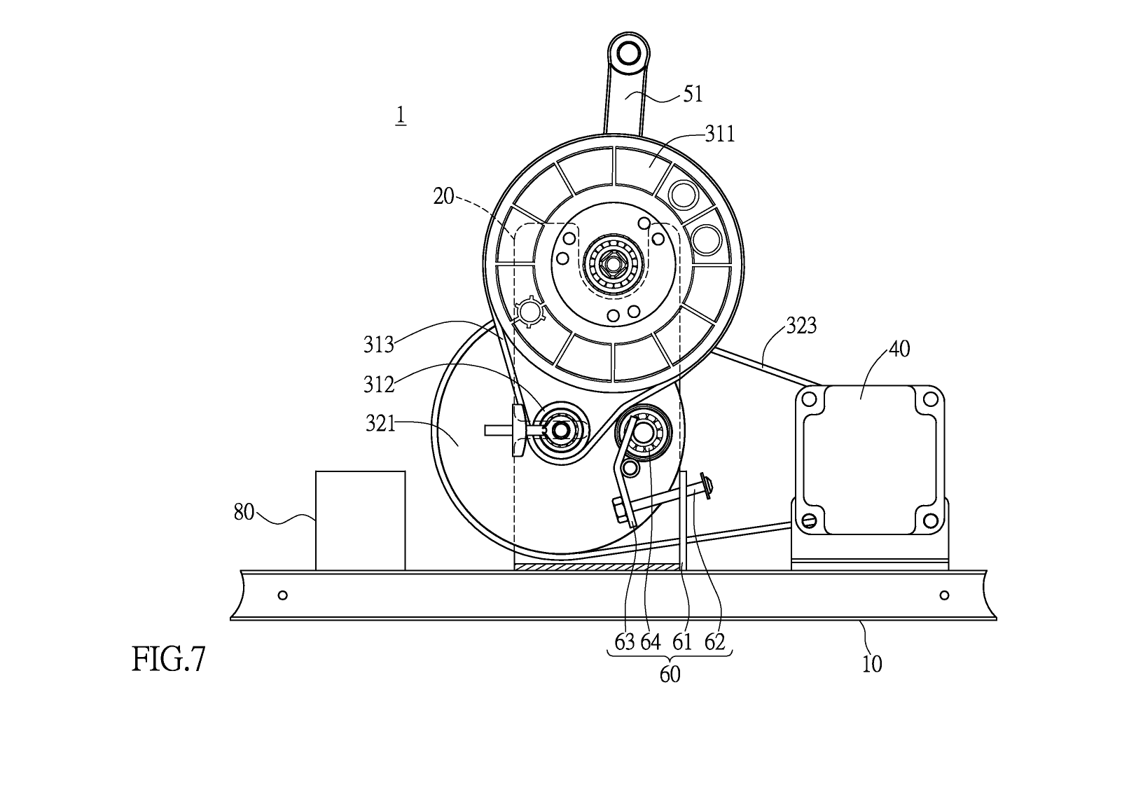

Further, referring to FIG. 6 and FIG. 7, side views of the power generating system having a multi-stage transmission structure of the present invention are shown. In both side views, some components are omitted for ease of explanation. As shown in FIG. 6, when the adjusting unit 62 is located at a first position relative to the support 61, the roller wheel 64 may be adjacent to the first transmission belt 313 and not abut against the first transmission belt 313. As shown in FIG. 7, when the adjusting unit 62 is located at a second position relative to the support 61, the roller wheel 64 is moved with the linkage unit 63 to abut against an outer side of the first transmission belt 313, to increase the tension of the first transmission belt 313 and thus increase resistance to rotation of the first driving wheel 311. Of course, in other embodiments, the roller wheel 64 may also abut against the first transmission belt 313 at any time. Specifically, the user can adjust resistance to driven rotation of the first driving wheel 311 through the adjusting unit 62, so as to meet different exercise requirements.

Furthermore, it should be noted that, this embodiment is exemplified above in that the first driving wheel 311 carries the first transmission wheel 312 through the first transmission belt 313, and in turn carries the second transmission wheel 321, and then carries the second driving wheel 322 through the second transmission belt 323. However, other configurations may be used in the actual application. For example, alternatively, the first driving wheel 311 directly drives the second driving wheel 322 through the first transmission belt 313, or another set of a transmission belt, a transmission wheel, and a driving wheel may also be added between the second driving wheel 322 and the second transmission wheel 321. In other words, in other embodiments, the user can increase or decrease the number of driving wheels, transmission wheels and transmission belts if desired.

### Second Embodiment

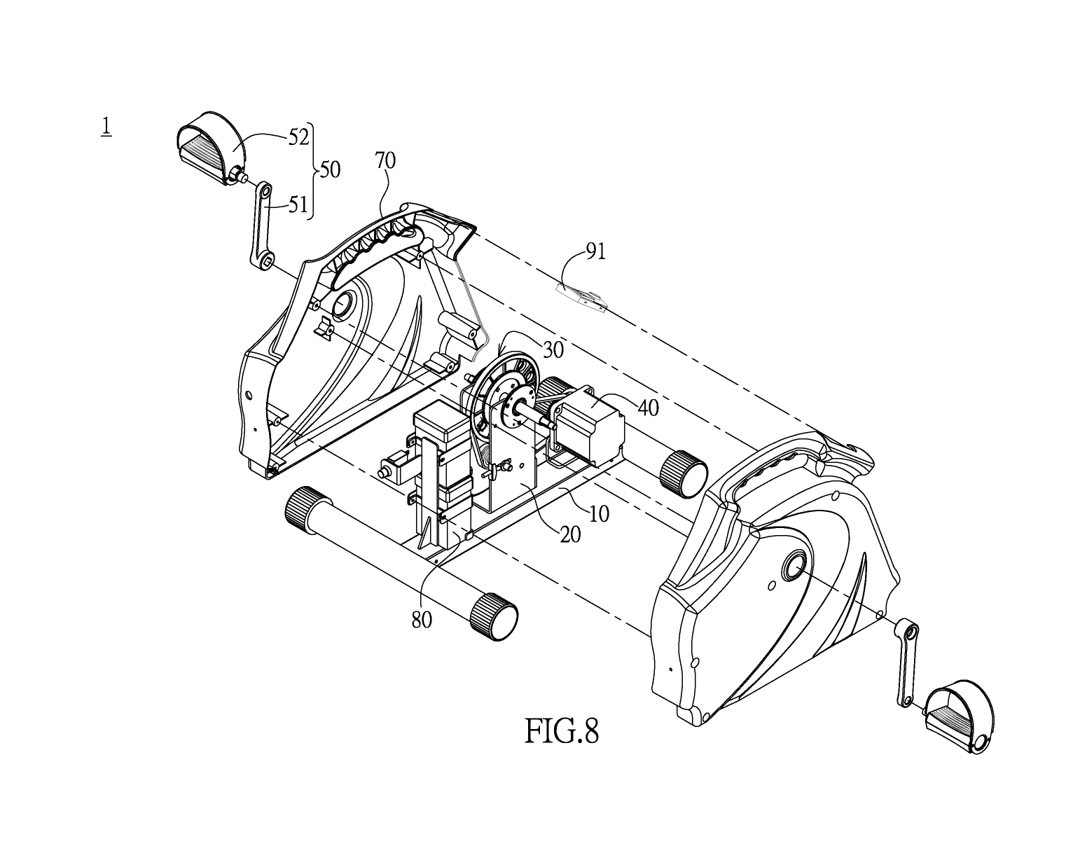

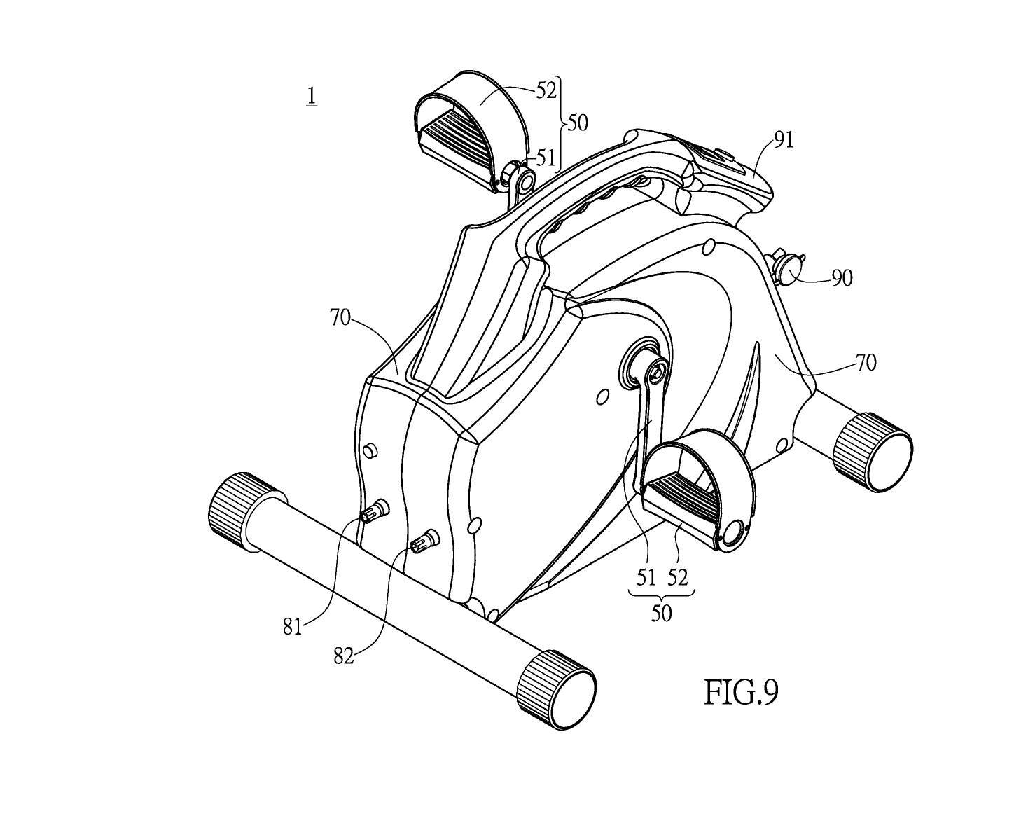

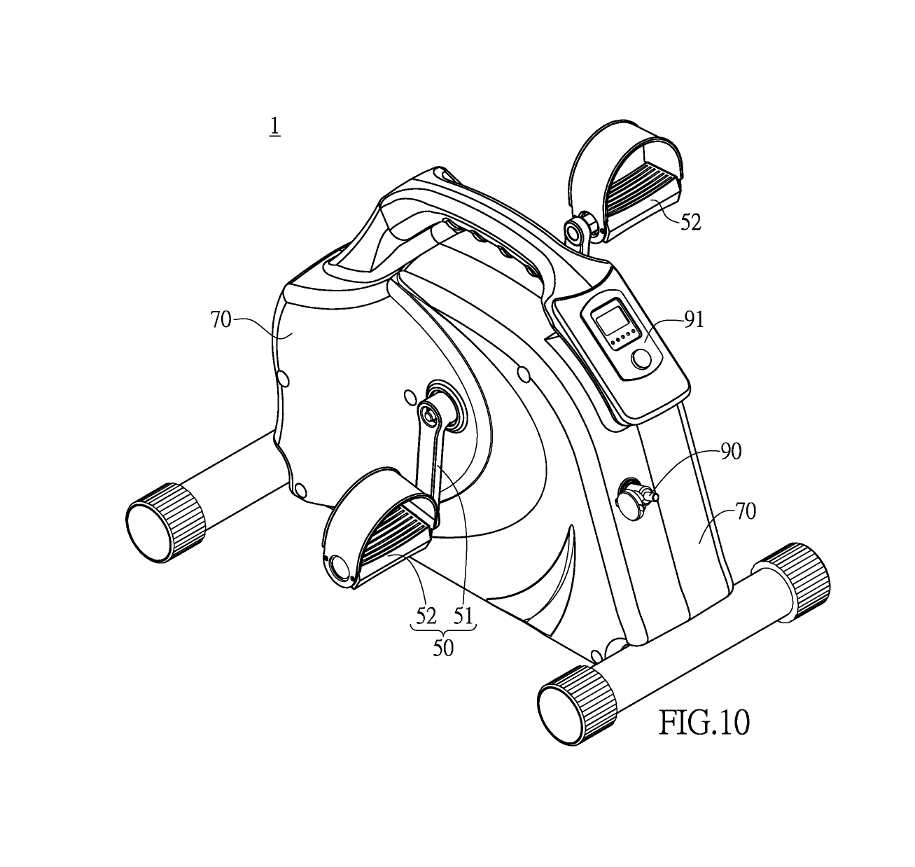

Referring to FIG. 8 to FIG. 10, exploded and assembled schematic views of a power generating system having a multi-stage transmission structure according to a second embodiment of the present invention are shown. As shown, a power generating system 1 comprises a base 10, a support 20, a multi-stage transmission structure 30, a power generating device 40, a manual operation module 50, a tension adjusting device (not shown, also referring to FIG. 1), a shell 70, a plurality of power storage devices 80, a power supply device 90, and a display device 91. The mutual relationship and individual construction of the base 10, the support 20, the multi-stage transmission structure 30, the power generating device 40, the manual operation module 50, and the tension adjusting device are the same as those in the first embodiment and are not described again here. In this embodiment, it is noted that, the shell 70 may be further disposed outside the power generating system 1 and the power generating device 40 may be further connected to the plurality of power storage devices 80 to directly store power generated by the power generating device 40 in the power storage devices 80. The power storage devices 80 may be further electrically connected to the power supply device 90, with which a user can charge an electronic device (for example, a mobile phone and various small household appliances). The form of connection between the power supply device 90 and the electronic device may be selected according to actual requirements. For example, the power supply device 90 may be a USB connector port or a vehicle charging connector port. The power storage devices 80 may be fixedly disposed on the base 10 or detachably disposed on the base 10. Furthermore, the power generating system 1 may be further provided with the display device 91, which may be electrically connected to the power storage devices 80 and the power generating device 40, for providing relevant data for a user to view.

It is worth mentioning that, in actual implementation, the power storage devices 80 may be further provided with a positive connection terminal 81 and a negative connection terminal 82 outside the shell 70, for connecting another power storage device to the power storage devices 80 of the power generating system 1 to be charged.

The description above is only preferred embodiments of the present invention, and is not intended to limit the scope of the present invention. All equivalent technical changes made according to the specification and drawings of the present invention should fall within the scope of the present invention.

What is claimed is:

1. A power generating system having a multi-stage transmission structure, comprising:
a multi-stage transmission structure including:
a driving module including a first driving wheel, a first transmission wheel, and a first transmission belt, wherein the diameter of the first driving wheel is greater than that of the first transmission wheel, and the first transmission belt is disposed around the first driving wheel and the first transmission wheel, so that the first driving wheel is capable of carrying the first transmission wheel; the first driving wheel and the first transmission wheel have a plurality of guiding trenches at respective outer edges, and the first transmission belt has a plurality of guiding structures, so that when the first transmission belt is disposed around the first driving wheel and the first transmission wheel, the guiding structures are correspondingly engaged in the guiding trenches, and
a transmission module including a second transmission wheel, a second driving wheel, and a second transmission belt, wherein the second transmission wheel is coaxially disposed with the first transmission wheel and rotates synchronously with the first transmission wheel; the diameter of the second transmission wheel is greater than that of the first transmission wheel and that of the second driving wheel, and the second transmission belt is disposed around the second transmission wheel and the second driving wheel, so that the second transmission wheel is capable of driving the second driving wheel to rotate;
a power generating device including a rotation shaft, wherein the second driving wheel is disposed around the rotation shaft;
a manual operation module connected to the first driving wheel, to enable a user to drive the first driving wheel to rotate, and thus carry the second driving wheel and the rotation shaft to rotate through the first transmission belt, the first transmission wheel, and the second transmission belt, so that the power generating device generates power; and
a tension adjusting device disposed adjacent to the first transmission belt to adjust tension of the first transmission belt.

2. The power generating system having a multi-stage transmission structure according to claim 1, further comprising a power storage device electrically connected to the power generating device to store power generated by the power generating device.

3. The power generating system having a multi-stage transmission structure according to claim 2, wherein the power storage device includes a three-phase bridge rectifier circuit and a filter circuit.

4. The power generating system having a multi-stage transmission structure according to claim 3, further comprising a power supply device electrically connected to the power storage device.

5. The power generating system having a multi-stage transmission structure according to claim 4, wherein the power storage device further includes a positive connection terminal and a negative connection terminal, for electrically connecting to another power storage device.

6. The power generating system having a multi-stage transmission structure according to claim 1, wherein the second transmission wheel and the second driving wheel have the guiding trenches at respective outer edges, and the second transmission belt have the guiding structures corresponding to the second guiding trenches, so that when the second transmission belt is disposed around the second transmission wheel and the second driving wheel, the guiding structures are correspondingly engaged in the guiding trenches.

7. The power generating system having a multi-stage transmission structure according to claim 1, wherein the tension adjusting device includes a support, an adjusting unit, a linkage unit, and a roller wheel, wherein the support and the multi-stage transmission structure is disposed on a base, the adjusting unit is movably disposed on the support, and the adjusting unit is connected to the roller wheel through the linkage unit and thus is capable of changing a position of the roller wheel; wherein when the adjusting unit is in a first position, the roller wheel does not abut against the first transmission belt, and when the adjusting unit is in a second position, the roller wheel is moved with the linkage unit to abut against an outer side of the first transmission belt, so as to increase tension of the first transmission belt.
